(19) United States
(12) Patent Application Publication
(10) Pub. No.: US 2026/0222849 A1
(43) Pub. Date: Jul. 30, 2026

(54) CONTROL APPARATUS, WIRELESS COMMUNICATION SYSTEM, WIRELESS PARAMETER CONTROL METHOD, AND PROGRAM

(71) Applicant: NTT, Inc., Tokyo (JP)

(72) Inventors: Toshiro NAKAHIRA, Tokyo (JP); Daisuke MURAYAMA, Tokyo (JP); So TAKATANI, Tokyo (JP); Takatsune MORIYAMA, Tokyo (JP)

(21) Appl. No.: 19/146,057

(22) PCT Filed: Jan. 11, 2023
(86) PCT No.: PCT/JP2023/000449

§ 371 Date: Jul. 7, 2025

(51) Int. Cl. H04W 24/04; H04W 24/08

(52) U.S. Cl. CPC H04W 24/04; H04W 24/08

(57) ABSTRACT

A control apparatus used in a wireless communication system including a plurality of base stations includes: a data storage unit that stores a wireless parameter for each failure pattern; and a parameter control unit that reads a wireless parameter corresponding to a failure pattern of a failure from the data storage unit in a case where it is determined that the failure of the failure pattern has occurred on the basis of operation state information of each base station, and notifies at least one base station of the read wireless parameter.

### TECHNICAL FIELD

The present invention relates to a wireless parameter control method for a base station (which may also be referred to as a radio base station) used in a wireless communication system.

### BACKGROUND ART

As use modes of wireless communication systems are diversified, use modes in which radio networks are required to have higher reliability than before, such as factories and distribution warehouses, are expected to increase. As an example of such a use mode, Non Patent Literature 1 describes a case where local 5G is deployed in a factory.

In order to improve the reliability of a radio network, it is desirable that wireless communication can be continued even in a case where some base stations are unavailable due to a failure. In order to solve this problem, for example, Non Patent Literature 2 discloses a technology of covering a communication interruption area by temporarily changing the depression angle (tilt) of a base station antenna around a base station in which a failure has occurred until the base station completes recovery.

### CITATION LIST

### Non Patent Literature

Non Patent Literature 1: NIPPON TELEGRAPH AND TELEPHONE EAST CORPORATION, “What is local 5G?, explaining methods and cases of introduction to factories”, https://bizdrive.ntt-east.co.jp/articles/dr00120-004.html Non Patent Literature 2: Iwamoto et al., “Approaches related to automation of tilt control of radio base station antennas”, https://orsj.org/nc2022s/wp-content/uploads/sites/12/2022/03/2022s-1-F-2.pdf

### SUMMARY OF INVENTION

### Technical Problem

In the conventional technology disclosed in Non Patent Literature 2 or the like, a neighboring base station capable of accommodating traffic and terminals accommodated in a base station in which a failure has occurred is limited to a base station capable of controlling the tilt. Therefore, in a wireless communication network in which there is a base station that cannot control the tilt, a communication interruption area cannot be covered in some cases.

That is, in the conventional technology, there is a problem that an area affected by a failure cannot be appropriately covered.

The present invention has been made in view of the above points, and an object of the present invention is to provide a technology that makes it possible to appropriately cover an area affected by a failure in a wireless communication system.

### Solution to Problem

According to the disclosed technology, there is provided a control apparatus used in a wireless communication system including a plurality of base stations, the control apparatus including:
a data storage unit that stores a wireless parameter for each failure pattern; and
a parameter control unit that reads a wireless parameter corresponding to a failure pattern of a failure from the data storage unit in a case where it is determined that the failure of the failure pattern has occurred on the basis of operation state information of each base station, and notifies at least one base station of the read wireless parameter.

### Advantageous Effects of Invention

According to the disclosed technology, there is provided a technology that makes it possible to appropriately cover an area affected by a failure in a wireless communication system.

### BRIEF DESCRIPTION OF DRAWINGS

FIG. 1 is a diagram illustrating a configuration example of a wireless communication system.

FIG. 2 is a flowchart illustrating an operation of a control apparatus 100.

FIG. 3 is a diagram illustrating an example of base station information.

FIG. 4 is a diagram illustrating an example of base station failure pattern information.

FIG. 5 is a diagram illustrating an example of wireless parameters of each base station for each failure pattern.

FIG. 6 is a diagram illustrating examples of operation state information.

FIG. 7 is a diagram for describing an example of a method of collecting operation state information.

FIG. 8 is a diagram for describing an example of a wireless parameter notification method.

FIG. 9 is a diagram illustrating a hardware configuration example of a device.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

Note that, in the following description of the present embodiment, a failure of a base station is assumed as a failure, but this is an example of a failure. A failure is not limited to a failure of a base station, and may be a device failure or a network failure. In addition, a case where radio waves cannot be temporarily transmitted due to radar detection or the like, or a case where congestion occurs in a base station and normal communication cannot be performed may be regarded as a failure.

### (Device Configuration Example)

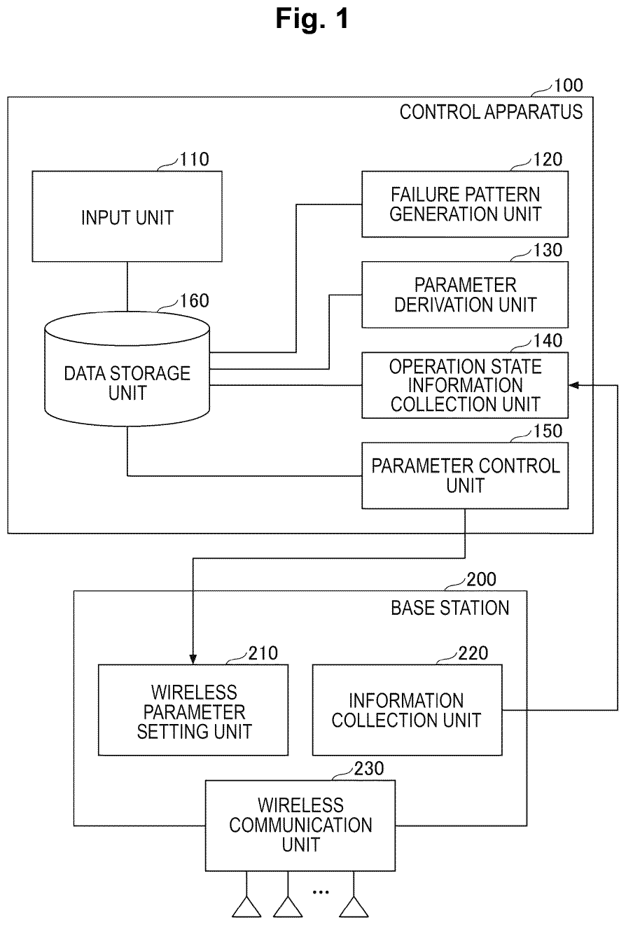

FIG. 1 illustrates a configuration example of a wireless communication system in the present embodiment. As illustrated in FIG. 1, the wireless communication system includes a control apparatus 100 and a base station 200. Although one control apparatus 100 can control a plurality of base stations, FIG. 1 illustrates one base station 200 as an example.

As illustrated in FIG. 1, the control apparatus 100 includes an input unit 110, a failure pattern generation unit 120, a parameter derivation unit 130, an operation state information collection unit 140, a parameter control unit 150, and a data storage unit 160. The operation of each unit will be described in the description of the operation to be described later.

The base station 200 includes a wireless parameter setting unit 210, an information collection unit 220, and a wireless communication unit 230. The wireless parameter setting unit 210 receives wireless parameters of which the control apparatus 100 notifies the wireless parameter setting unit 210, and sets the wireless parameters in its own station (base station 200). The information collection unit 220 collects operation state information of its own station (base station 200) and notifies the control apparatus 100 of the collected information. The wireless communication unit 230 performs wireless communication with a terminal accommodated by the base station 200.

In addition, “the failure pattern generation unit 120, the parameter derivation unit 130, the operation state information collection unit 140, the parameter control unit 150, and the data storage unit 160” may be implemented by one device (computer) or may be implemented by a plurality of computers. For example, the parameter control unit 150 and the data storage unit 160 may be included in the control apparatus 100, and each of the failure pattern generation unit 120, the parameter derivation unit 130, and the operation state information collection unit 140 may be a separate device provided outside the control apparatus 100.

Furthermore, in a case where the control apparatus 100 includes a plurality of computers, the control apparatus 100 may be referred to as a control system.

The data storage unit 160 stores information input in advance from the input unit 110, and stores a calculation result and the like. The information input in advance is, for example, base station information to be described later. The data storage unit 160 may be a storage device (memory or the like) in the computer (control apparatus 100) or a database device in the control system.

### (Device Operation)

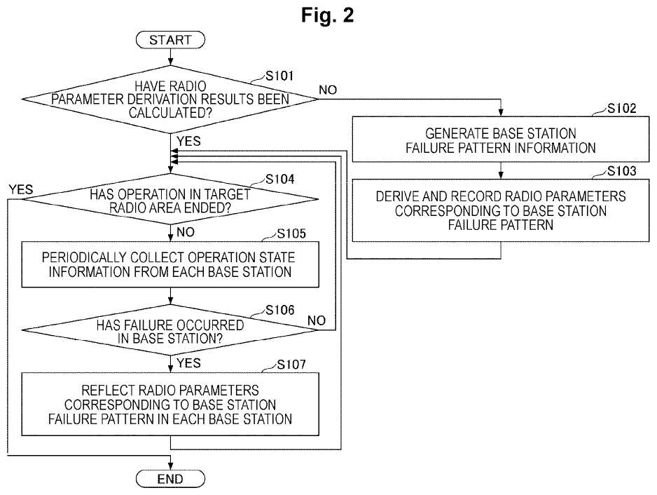

The operation of the control apparatus 100 will be described in detail along the procedure in the flowchart of FIG. 2. In the following operation, a radio area of one or more base stations to be controlled by the control apparatus 100 is referred to as a target radio area.

### <S101>

In S101, the failure pattern generation unit 120 refers to the data storage unit 160 to determine whether wireless parameter derivation results corresponding to failure patterns have been calculated. If the determination result is No (not calculated), the processing proceeds to S102, and if the determination result is Yes (calculated), the processing proceeds to S104.

### <S102>

In S102, the failure pattern generation unit 120 generates base station failure pattern information on the basis of operating base station information read from the data storage unit 160, and stores the generated base station failure pattern information in the data storage unit 160.

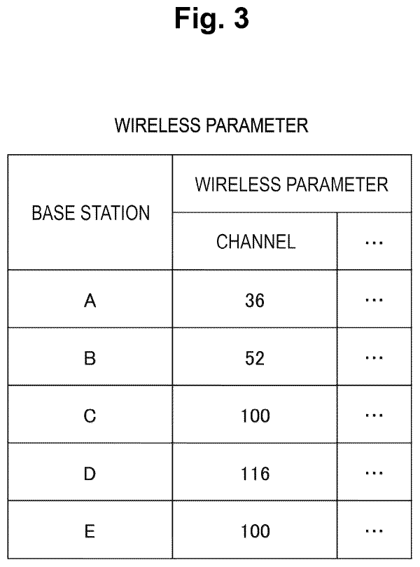

FIG. 3 illustrates an example of the base station information. The base station information has, for each base station, wireless parameters that can be set in the base station. Although (the number of) a channel is illustrated as a wireless parameter in FIG. 3, this is an example. The wireless parameters included in the base station information are not limited to the channels. For example, wireless parameters such as MCS, transmission power, a radio method, the number of MIMO layers, a configuration of carrier aggregation (CA), a tilt, a beam width, a direction of a beam, and a maximum allowable amount of traffic may be included in the base station information.

In addition, the base station information may include information such as “locations, heights, and information on surrounding buildings” of the operating base stations as information other than the wireless parameters.

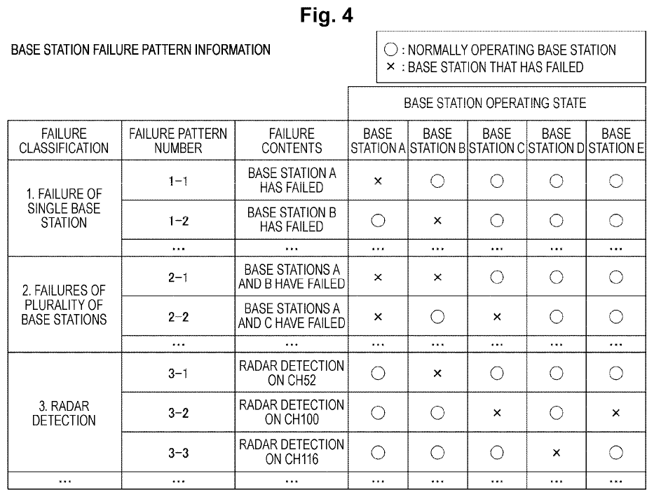

FIG. 4 illustrates an example of the base station failure pattern information. In the example illustrated in FIG. 4, the base station failure pattern information includes information on failure contents and a base station operating state for each failure classification and each failure pattern (failure pattern number).

The failure pattern generation unit 120 creates the base station failure pattern information by covering, in each failure classification, all possible failure patterns for a plurality of base stations to be used. For example, in the example of FIG. 4, “1. Failure of single base station” sets failure patterns in a case where each of base stations A to E to be used fails. However, covering all the possible failure patterns is an example. There may be a case where some of all the possible failure patterns are not included in the base station failure pattern information.

Note that the base station failure pattern information may be manually created in advance, input from the input unit 110, and stored in the data storage unit 160.

### <S103>

In S103, the parameter derivation unit 130 refers to the data storage unit 160, derives wireless parameters of each base station for each failure pattern on the basis of the operating base station information and the base station failure pattern information, and stores information on the derived wireless parameters in the data storage unit 160.

The parameter derivation unit 130 derives (determines) wireless parameters of each base station in a failure pattern so as to cover an area affected by a failure of a base station indicated in the failure pattern (for example, an area in which communication is interrupted). Covering an area affected by a failure of a certain base station means, for example, accommodating terminals in the area by a neighboring base station of the base station.

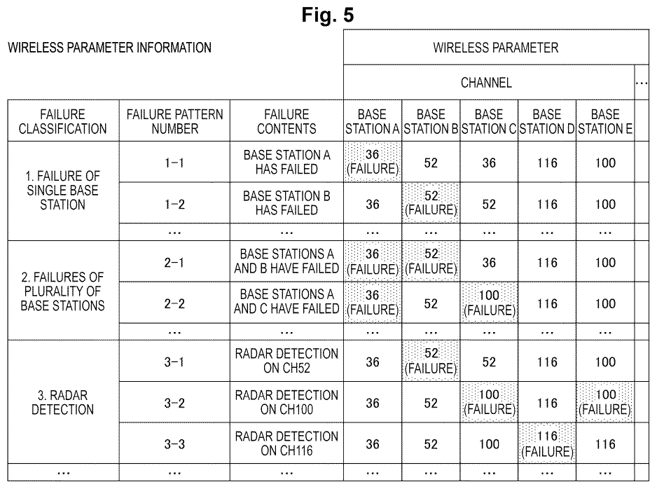

FIG. 5 illustrates an example of wireless parameters of each base station for each failure pattern. An example of deriving wireless parameters will be described with reference to FIG. 5.

In the failure pattern with the failure pattern number 1-1 illustrated in FIG. 5 (the pattern in which only the base station A using only the channel 36 fails), for example, assuming that there is overlap between the area of the base station A and the area of the base station C, and that the base station C can set any of the channels 36, 52, and 100, the channel of the base station C is set to 36 in order to cover the area of the base station A. Furthermore, for the base station C, in addition to the wireless parameter of the channel, wireless parameters such as transmission power may be determined so as to cover a wider range.

In addition, the technology according to the present embodiment is not limited to the wireless parameter control of a base station having a single radio system. With the technology according to the present embodiment, it is possible to simultaneously control a plurality of types of devices (a base station, an antenna, and the like) or simultaneously control one or more base stations having a plurality of types of wireless communication systems.

Therefore, in deriving wireless parameters, for example, both wireless parameters of a base station of a wireless LAN system and wireless parameters of a base station of 5G can be derived as wireless parameters for covering the area of a certain base station.

Note that the wireless parameter information as illustrated in FIG. 5 may be manually created in advance, input from the input unit 110, and stored in the data storage unit 160.

### <S104>

In S104, the parameter control unit 150 determines whether the operation in the target radio area has ended. In the case of Yes (end), the processing ends, and in the case of No (not end), the processing proceeds to S105.

### <S105>

In S105, the operation state information collection unit 140 periodically collects operation state information from each base station 200 and stores the collected operation state information in the data storage unit 160.

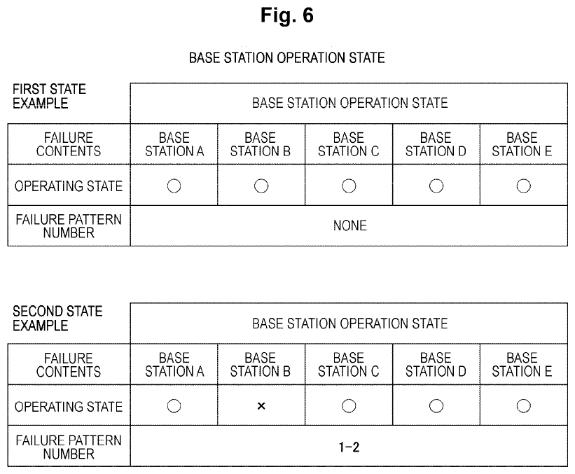

FIG. 6 illustrates examples of the operation state information. FIG. 6 illustrates the first state example and the second state example. In the first state example, all the base stations operate normally. In the second state example, a failure occurs in the base station B. This failure pattern corresponds to the failure pattern number 1-2.

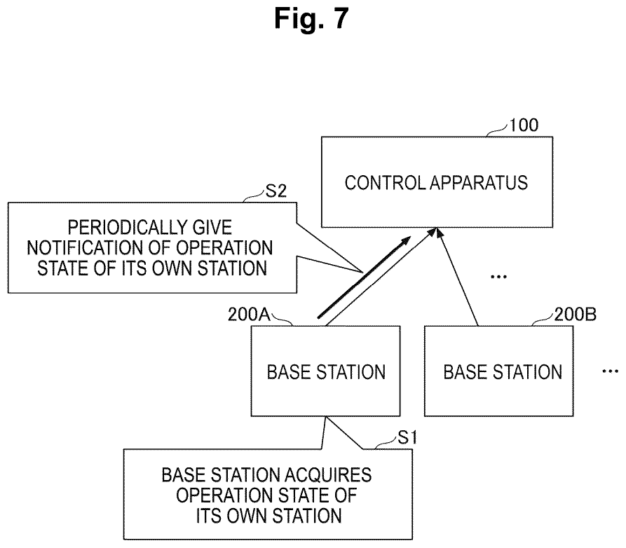

An example of a method of collecting the operation state information will be described with reference to FIG. 7. In S1, each base station 200 acquires operation state information of its own station by the information collection unit 220. In S2, each base station notifies the control apparatus 100 of the operation state information of its own station. S1 and S2 are periodically performed.

Note that the method of collecting the operation state information as described above is an example. For example, a network monitoring device may collect the operation state information from each base station 200, and the network monitoring device may notify the control apparatus 100 of the operation state information.

### <S106>

In S106, the parameter control unit 150 refers to the operation state information stored in the data storage unit 160 and determines whether a failure has occurred in any of the base stations. In the case of Yes (failure has occurred), the processing proceeds to S107, and in the case of No (failure has not occurred), the processing returns to S104.

### <S107>

In S107, the parameter control unit 150 reads wireless parameters of each base station 200 corresponding to the failure pattern of the occurring failure from the data storage unit 160 by referring to the wireless parameter information stored in the data storage unit 160, and notifies each corresponding base station 200 of the read wireless parameters.

Note that the parameter control unit 150 may give notification of wireless parameters for all the base stations (the base station that has failed may be excluded) corresponding to the failure pattern in the wireless parameter information to all the base stations (the base station that has failed may be excluded), or may give notification of wireless parameters of some of all the base stations (the base station that has failed may be excluded) corresponding to the failure pattern to some of the base stations.

For example, the parameter control unit 150 may give notification of wireless parameters only to a neighboring base station that can cover the area of the base station that has failed.

In addition, for example, in order to cover the area of a certain base station, the parameter control unit 150 may simultaneously notify both a base station of a wireless LAN system and a base station of 5G of their wireless parameters.

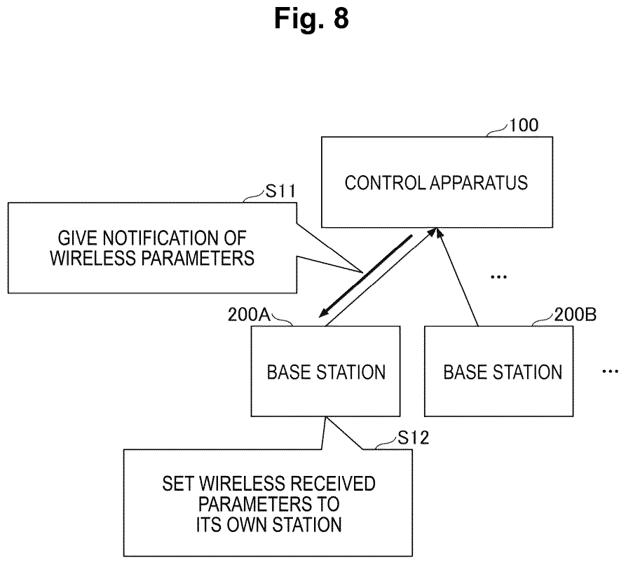

FIG. 8 illustrates an example of processing contents of S107. As illustrated in FIG. 8, in S11, the control apparatus 100 (specifically, the parameter control unit 150) notifies each base station 200 of the wireless parameters. Each base station 200 sets the wireless parameters received from the control apparatus 100 to its own station by the wireless parameter setting unit 210. Each base station 200 that has set the wireless parameters performs an operation of wireless communication according to the wireless parameters.

Note that, in S107, the operation state information collection unit 140 may further collect information from the base station in which the failure has occurred, and the parameter control unit 150 may perform wireless parameter control or communication control using the information.

For example, for a base station that performs communication by bundling a plurality of channels, in a case where a failure occurs in the base station, the control apparatus 100 may collect, from the base station, information indicating which channel has failed as detailed information of the failure, and perform wireless parameter control of a neighboring base station so as to cover only the channel that has failed.

In addition, the parameter derivation unit 130 of the control apparatus 100 may further derive parameters of a backhaul network in accordance with the derivation of the wireless parameters of the base stations, and when a failure occurs in a base station, the parameter control unit 150 may further control the parameters of the backhaul network in addition to the wireless parameters of the base stations.

For example, the parameters may be controlled such that more traffic can be transmitted and received for a line on the core network side of a neighboring base station covering the area that has failed.

### (Hardware Configuration Example)

Each of the control apparatus 100 and the base station 200 can be implemented, for example, by causing a computer to execute a program. This computer may be a physical computer or may be a virtual machine on a cloud. The control apparatus 100 and the base station 200 are collectively referred to as a “device”.

That is, the device can be implemented by a program corresponding to processing performed in the device being executed by use of hardware resources such as a CPU and a memory built in the computer. The above program can be stored and distributed by being recorded in a computer-readable recording medium (portable memory or the like). Furthermore, the above program can also be provided through a network such as the Internet or an electronic mail.

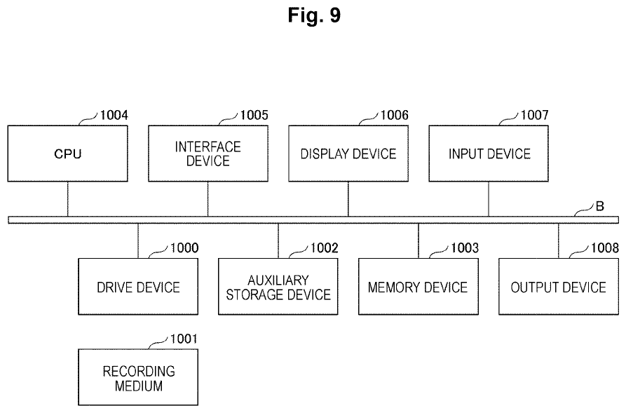

FIG. 9 is a diagram illustrating a hardware configuration example of the above computer. The computer of FIG. 9 includes a drive device 1000, an auxiliary storage device 1002, a memory device 1003, a CPU 1004, an interface device 1005, a display device 1006, an input device 1007, an output device 1008, and the like, which are connected to each other by a bus BS. Note that the computer may further include a GPU.

The program for implementing the processing in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002, and stores the program. The CPU 1004 implements a function related to the device in accordance with the program stored in the memory device 1003. The interface device 1005 is used as an interface for connecting to a network or the like. The display device 1006 displays a graphical user interface (GUI) or the like according to the program. The input device 1007 includes a keyboard and a mouse, a button, a touch panel, or the like, and is used to input various operation instructions. The output device 1008 outputs a calculation result.

### Summary of Embodiment, Effects, and Like

As described above, the technology described in the present embodiment provides a technology that makes it possible to appropriately cover an area affected by a failure in a wireless communication system.

More specifically, according to the technology of the present embodiment, in order to accommodate traffic and terminals accommodated in a base station in which a failure has occurred in a neighboring base station without any problem, it is possible to quickly perform wireless parameter control of the neighboring base station in response to the failure of the base station.

With regard to the above embodiment, the following supplementary notes will be further disclosed.

### <Supplementary Notes>

### (Supplementary Note 1)

A control apparatus used in a wireless communication system including a plurality of base stations, the control apparatus including:
a data storage unit that stores a wireless parameter for each failure pattern; and
a parameter control unit that reads a wireless parameter corresponding to a failure pattern of a failure from the data storage unit in a case where it is determined that the failure of the failure pattern has occurred on the basis of operation state information of each base station, and notifies at least one base station of the read wireless parameter.

### (Supplementary Note 2)

The control apparatus according to supplementary note 1, further including a parameter derivation unit that derives a wireless parameter so as to cover an area affected by a failure for each failure pattern, and stores the derived wireless parameter in the data storage unit.

### (Supplementary Note 3)

The control apparatus according to supplementary note 1 or 2, further including an operation state information collection unit that collects the operation state information of each base station.

### (Supplementary Note 4)

A wireless communication system including: the control apparatus according to any one of supplementary notes 1 to 3; and the plurality of base stations.

### (Supplementary Note 5)

A wireless parameter control method executed by a control apparatus used in a wireless communication system including a plurality of base stations, wherein
the control apparatus includes a data storage unit that stores a wireless parameter for each failure pattern,
reads a wireless parameter corresponding to a failure pattern of a failure from the data storage unit in a case where it is determined that the failure of the failure pattern has occurred on the basis of operation state information of each base station, and notifies at least one base station of the read wireless parameter.

### (Supplementary Note 6)

A non-transitory storage medium storing a program for causing a computer to function as each unit in the control apparatus according to any one of supplementary notes 1 to 3.

Although the present embodiment has been described above, the present invention is not limited to such a specific embodiment, and various modifications and changes can be made within the scope of the gist of the present invention described in the claims.

### REFERENCE SIGNS LIST

100 Control apparatus
110 Input unit
120 Failure pattern generation unit
130 Parameter derivation unit
140 Operation state information collection unit
150 Parameter control unit
160 Data storage unit
200 Base station
210 Wireless parameter setting unit
220 Information collection unit
230 Wireless communication unit
1000 Drive device
1001 Recording medium
1002 Auxiliary storage device
1003 Memory device
1004 CPU
1005 Interface device
1006 Display device
1007 Input device
1008 Output device

1. A control apparatus used in a wireless communication system including a plurality of base stations, the control apparatus comprising:
a processor; and
a memory that includes instructions, which when executed, cause the processor to execute:
storing, in a data storage, a wireless parameter for each failure pattern; and
reading, from the data storage, a wireless parameter corresponding to a failure pattern of a failure in a case where it is determined that the failure of the failure pattern has occurred based on operation state information of each base station, and notifying at least one base station of the read wireless parameter.

2. The control apparatus according to claim 1, wherein the instructions, which when executed, cause the processor to execute deriving a wireless parameter so as to cover an area affected by a failure for each failure pattern, and storing the derived wireless parameter in the data storage.

3. The control apparatus according to claim 1, wherein the instructions, which when executed, cause the processor to execute collecting the operation state information of each base station.

4. A wireless communication system comprising:
the control apparatus according to claim 1; and
the plurality of base stations.

5. A wireless parameter control method executed by a control apparatus used in a wireless communication system including a plurality of base stations, the control apparatus including a data storage that stores a wireless parameter for each failure pattern, the wireless parameter control method comprising:
reading, from the data storage, a wireless parameter corresponding to a failure pattern of a failure in a case where it is determined that the failure of the failure pattern has occurred based on operation state information of each base station, and notifying at least one base station of the read wireless parameter.

6. A non-transitory computer-readable recording medium having computer-readable instructions stored thereon, which when executed, cause a computer to execute the wireless parameter control method according to claim 5.
